(19) United States
(12) Patent Application Publication
(10) Pub. No.: US 2009/0143210 A1
(43) Pub. Date: Jun. 4, 2009

(54) Parallel folding apparatus of folding machine

(76) Inventor: Takao Watanabe, Chiba (JP)

Correspondence Address: BIRCH STEWART KOLASCH & BIRCH, PO BOX 747, FALLS CHURCH, VA, 22040-0747, US

(21) Appl. No.: 10/568,181

(22) PCT Filed: Apr. 27, 2005
(86) PCT No.: PCT/JP2005/007994

§ 371 Date: Feb. 13, 2006

(30) Foreign Application Priority Data
Apr. 30, 2004 (JP) 2004-136129

(51) Int. Cl. B31F 1/10

(52) U.S. Cl. 493/428

(57) ABSTRACT

A parallel folding apparatus of a folding machine, which can automatically exercise position control of brush guides in accordance with folding specifications while the machine is in operation, is provided. In the parallel folding apparatus of the folding machine, comprising:
a first jaw cylinder (26), an upper second jaw cylinder (27), and a lower second jaw cylinder (28) arranged, with their circumferential surfaces in contact with one another, grippers (36a to 36d) of the upper second jaw cylinder, or grippers (36a to 36d, 38b, 38d) of the upper second jaw cylinder and the lower second jaw cylinder, being arranged to double-parallel-fold a signature in cooperation with knives of the first jaw cylinder; and
brush guides (41) disposed along the circumferential surface of the first jaw cylinder located upstream, in the rotating direction, of the points of contact of the first jaw cylinder with the upper second jaw cylinder and the lower second jaw cylinder,
each brush guide is provided so as to be movable toward and away from the circumferential surface of the first jaw cylinder by a pair of (right and left) drive portions (44a, 44b) comprising threaded shafts (51a, 51b) and brackets (58a, 58b) driven by motors (47a, 47b) with rotary encoders (55a, 55b).

### TECHNICAL FIELD

This invention relates to a parallel folding apparatus of a folding machine, which can smoothly perform transfer of a signature between cylinders during parallel folding.

### BACKGROUND ART

A web rotary printing press is equipped with a folding machine for cutting a web, which has been dried and cooled after printing, into predetermined lengths, and folding the cut web in a width direction or a lengthwise direction.

The folding machine is available with various structures and, for example, is equipped with a parallel folding apparatus as shown in FIG. 5 (see Patent Document 1).

This parallel folding apparatus has a cut-off cylinder 1, a folding cylinder 2, a first jaw cylinder 3, and a second jaw cylinder 4 opposed to one another in contact with one another and rotating in directions of arrows in the drawing. A web 4, which has been fed from a former (not shown), is cut to predetermined dimensions by a cut-off knife 5 of the cut-off cylinder 1. The front end of the cut web is transported by a pin 7 of the folding cylinder 2, and then the cut web is parallel-folded between a single folding knife 12 of the folding cylinder 2 and a gripper board 8 of the first jaw cylinder 3 to form a signature 6. In the case of a single parallel fold, the signature 6 is transported, unchanged, toward a chopper (not shown) by a gripper 9 of the second jaw cylinder 4. In the case of a double parallel fold or a delta fold, the signature 6 is further parallel-folded between a double folding knife 10 of the first jaw cylinder 3 and a gripper board (not shown) of the second jaw cylinder 4 to form a double parallel fold or a delta fold. The so folded signature 6 is transported toward the chopper.

In FIG. 5, 11a to 11c denote brush guides for guiding the signature 6 transported along the circumferential surfaces of the cylinders 2 and 3.

Patent Document 1: Japanese Utility Model Publication No. 1995-54205.

### DISCLOSURE OF THE INVENTION

### Problems to be Solved by the Invention

In a parallel folding apparatus of a folding machine as described in Patent Document 1, particularly when the signature 6 after single folding is parallel-folded between the double folding knife 10 of the first jaw cylinder 3 and the gripper board 9 of the second jaw cylinder 4 so as to be double-folded or delta-folded, the rear end of the signature 6 may be bent to deteriorate folding accuracy.

Thus, it has been customary practice to apply a suitable contact pressure to the signature 6, which is being transported, by the brush guides 11a to 11c, thereby avoiding the occurrence of a possible bend. However, the conventional brush guides 11a to 11c enable the adjustment of the contact pressure to be made using complete locking by bolts, or a handle operation outside the machine. This has posed the following problems: In the case of complete locking, it is impossible to adjust the contact pressure according to the folding specifications. In making an adjustment by the handle operation, a heavy burden is imposed on an operator, skill is required, and the contact pressure has to be adjusted while the machine is shut down. Similar problems occur when folding takes place, or does not take place, between the folding cylinder and the jaw cylinder.

An object of the present invention is, therefore, to provide a parallel folding apparatus of a folding machine, which can automatically exercise the position control of brush guides in accordance with the folding specifications while the machine is in operation.

### Means for Solving the Problems

The parallel folding apparatus of a folding machine according to the present invention, for attaining the above object, is a parallel folding apparatus of a folding machine, comprising:

a first cylinder and a second cylinder arranged, with circumferential surfaces of the first cylinder and the second cylinder being in contact with each other, gripping/holding means of the second cylinder being arranged to parallel-fold a sheet in cooperation with knives of the first cylinder; and

a brush guide disposed along the circumferential surface of the first cylinder located upstream, in a rotating direction, of a point of contact between the first cylinder and the second cylinder,

and wherein the brush guide is provided so as to be movable toward and away from the circumferential surface of the first cylinder by drive means.

The parallel folding apparatus is characterized in that the brush guide is located at an operating position close to the circumferential surface of the first cylinder when the sheet is folded between the first cylinder and the second cylinder, and the brush guide is separated from the operating position when the sheet is not folded between the first cylinder and the second cylinder.

The parallel folding apparatus is also characterized in that the first cylinder is a first jaw cylinder for forming a signature in cooperation with a folding cylinder, and the second cylinder is a second jaw cylinder for folding the signature in cooperation with the first jaw cylinder, or for receiving the signature from the first jaw cylinder without folding the signature.

The parallel folding apparatus is also characterized by having a plurality of the second jaw cylinders and a plurality of the brush guides.

The parallel folding apparatus is also characterized in that the drive means are provided at opposite end portions of a bar, which extends in an axial direction while supporting the brush guide, and are driven and controlled independently of each other.

The parallel folding apparatus is also characterized in that the drive means comprises a motor, a threaded shaft driven by the motor, and a bracket screwed to the threaded shaft, and the bar is supported pivotably about the bracket.

The parallel folding apparatus is also characterized in that the drive means is provided at a bar supporting the brush guide, and is driven and controlled according to folding specifications by control means.

The parallel folding apparatus also comprises a folding specifications input unit for inputting folding specifications, and control means for controlling the drive means according to the folding specifications inputted into the folding specifications input unit.

The parallel folding apparatus further comprises an adjustment input unit for actuating the drive means to adjust the contact pressure of the brush guide on the sheet being parallel-folded.

The parallel folding apparatus is also characterized in that the drive means is a pair of motors provided at opposite end portions of the brush guide, and the control device controls at least one of the pair of motors based on an input into the adjustment input unit.

The parallel folding apparatus is also characterized in that the second jaw cylinder comprises an upper second jaw cylinder and a lower second jaw cylinder paired with the brush guides,

is characterized by being capable of performing upward merger delivery for transferring the sheet from the first jaw cylinder only to the upper second jaw cylinder, and up-and-down allocation delivery for transferring the sheet alternately from the first jaw cylinder to the upper second jaw cylinder, and from the first jaw cylinder to the lower second jaw cylinder,

and further comprises control means for controlling the drive means so as to separate the brush guide located beside the lower second jaw cylinder from an operating position during the upward merger delivery.

### EFFECTS OF THE INVENTION

According to the present invention with the above features, the position control of the brush guides can be automatically exercised in accordance with the folding specifications, while the machine is in operation, by controlling the drive means to adjust the contact pressure, etc.

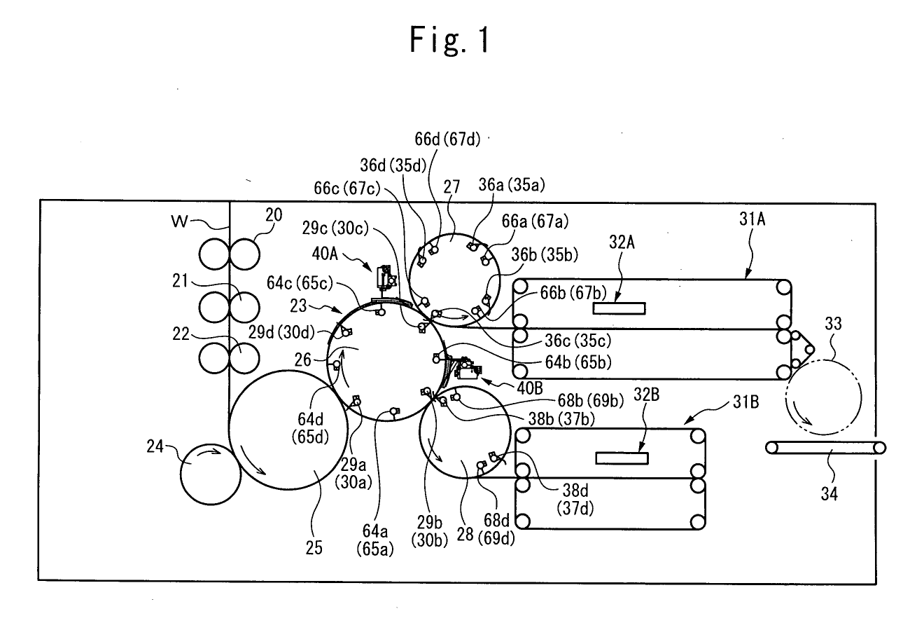

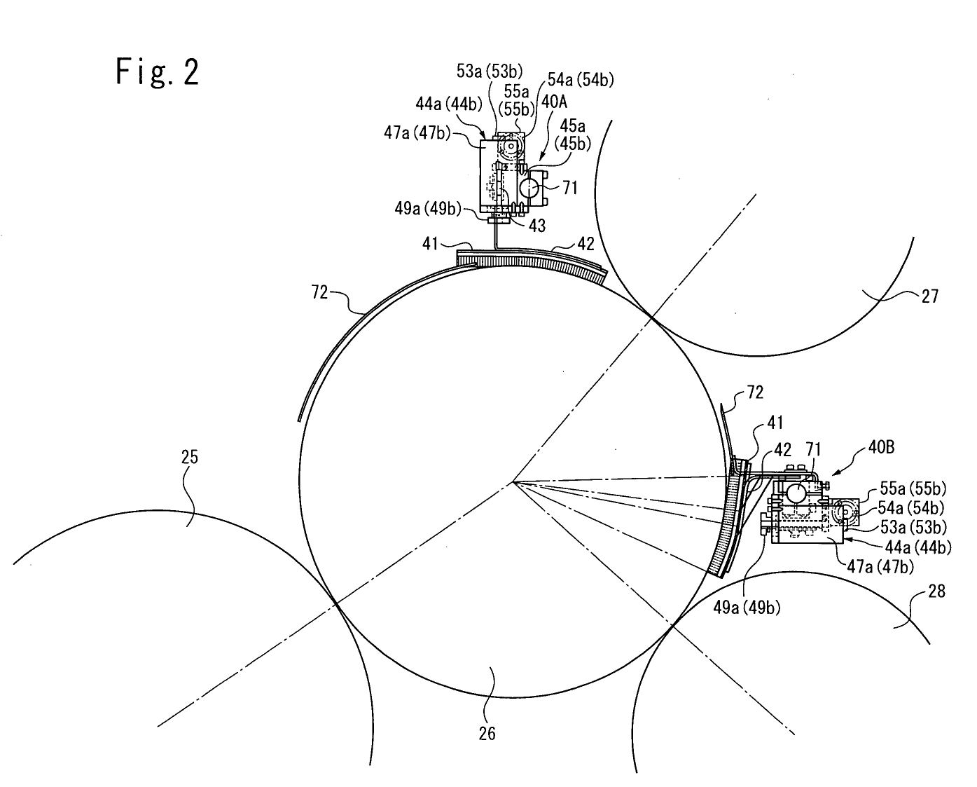

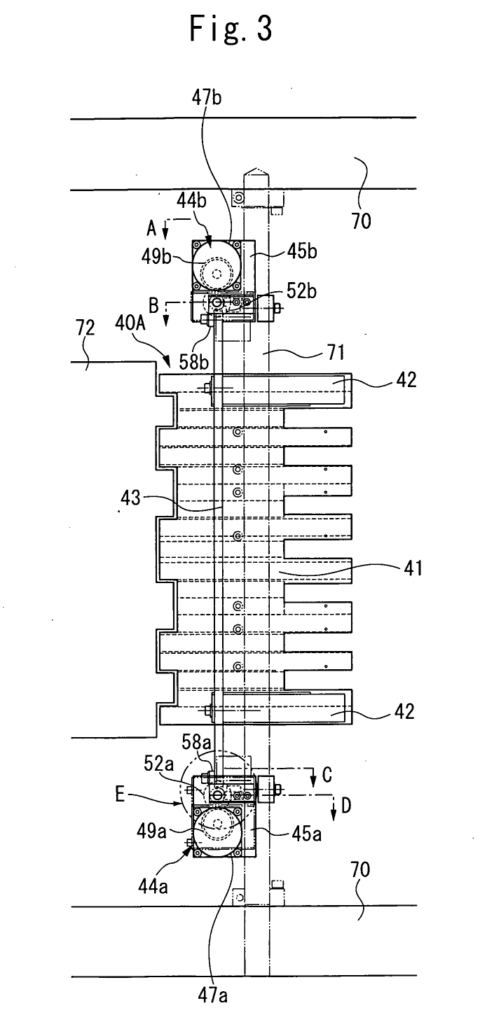

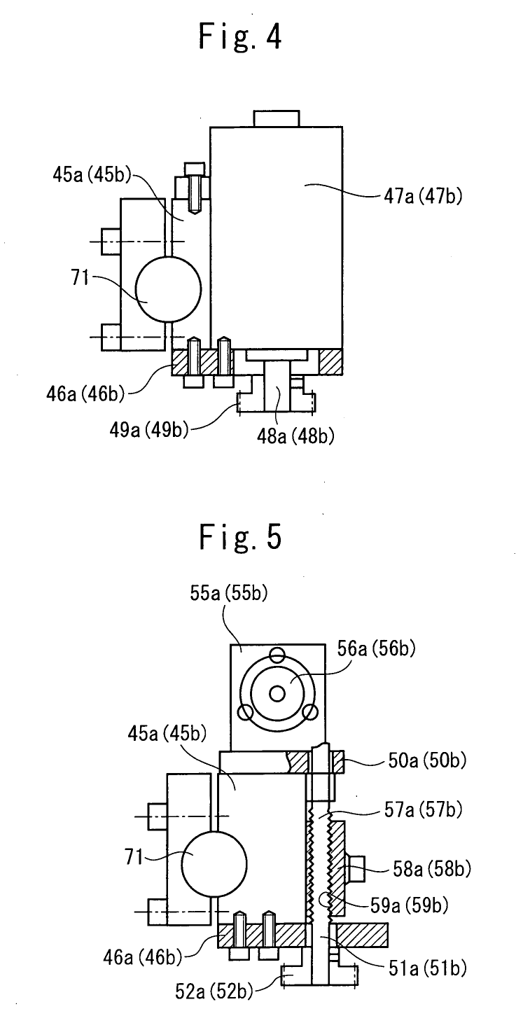

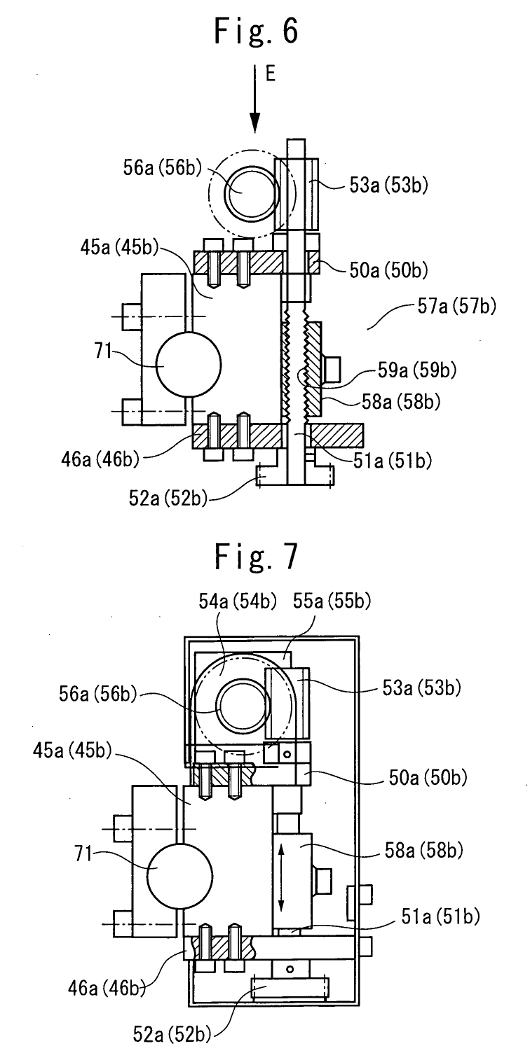

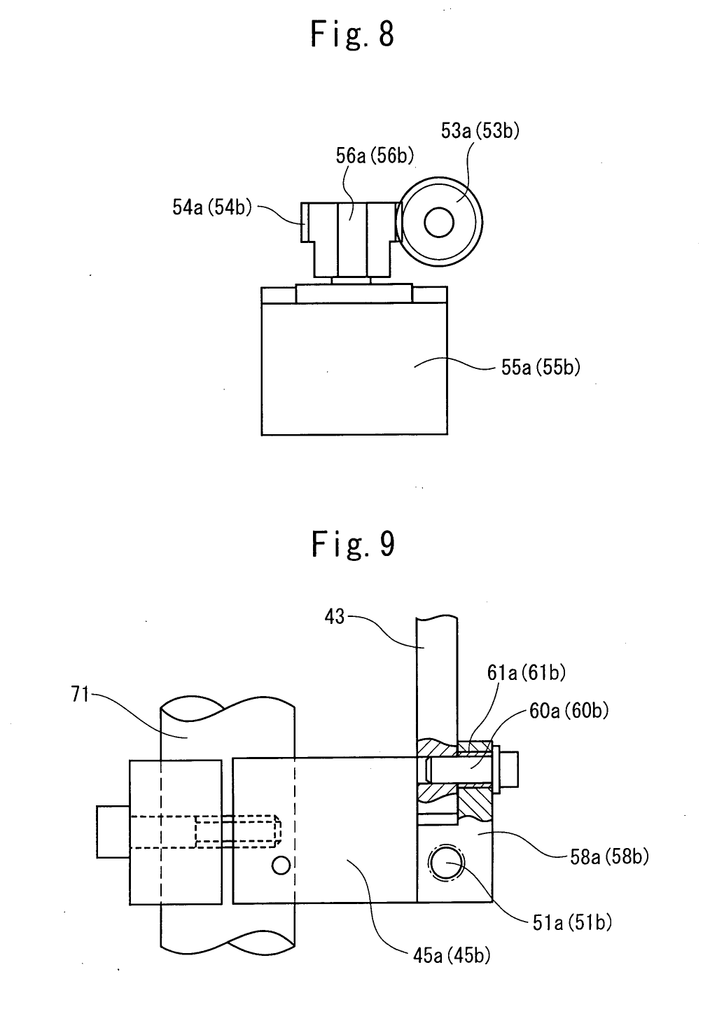

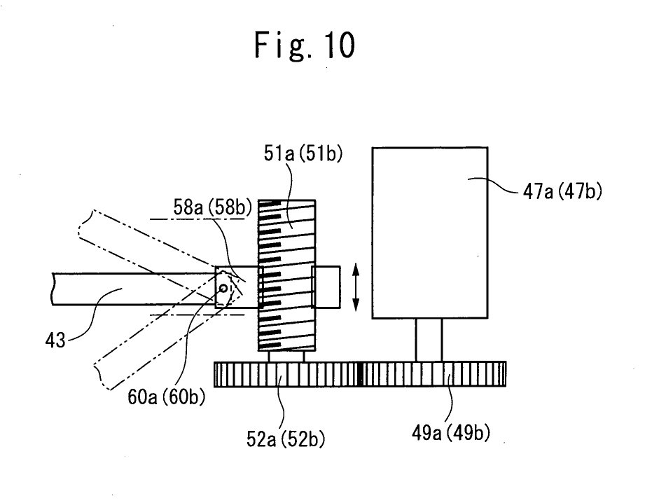

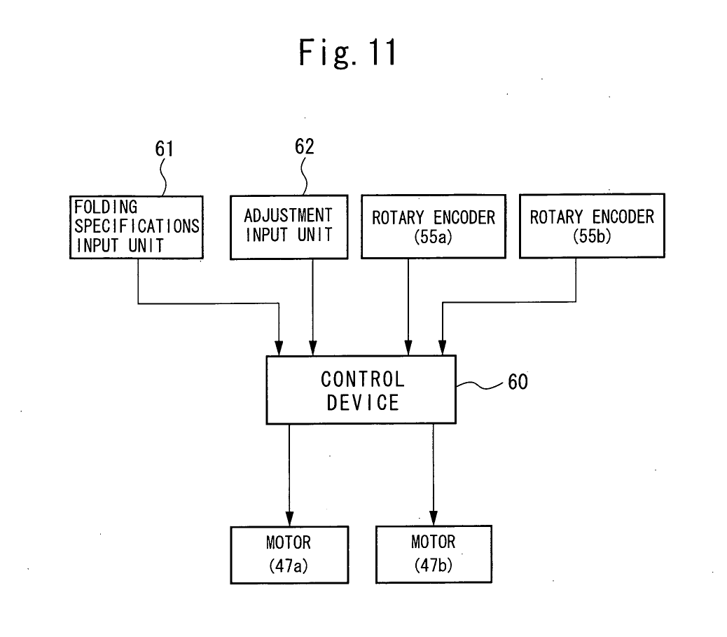

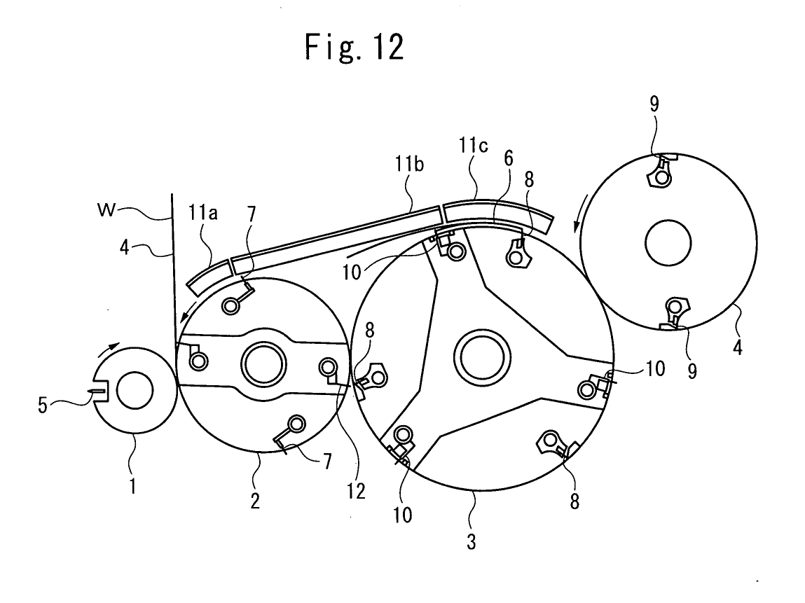

### BRIEF DESCRIPTION OF THE DRAWINGS

[FIG. 1] A schematic side view of a folding machine of a rotary printing press, showing an embodiment of the present invention.

[FIG. 2] An enlarged side view of essential parts of the folding machine.

[FIG. 3] An enlarged plan view of the essential parts.

[FIG. 4] A sectional view taken along line A in FIG. 3.

[FIG. 5] A sectional view taken along line B in FIG. 3.

[FIG. 6] A sectional view taken along line C in FIG. 3.

[FIG. 7] A sectional view taken along line D in FIG. 3.

[FIG. 8] A view taken in the direction of an arrow E in FIG. 6.

[FIG. 9] A detail view of F in FIG. 3.

[FIG. 10] An explanation drawing of the actions of a bar.

[FIG. 11] A control block chart.

[FIG. 12] A schematic side view of a parallel folding apparatus of a conventional folding machine.

20 nipping roller, 21 cross perforation cylinder, 22 nipping roller, 23 parallel folding apparatus, 24 cut-off cylinder, 25 folding cylinder, 26 first jaw cylinder, 27 upper second jaw cylinder, 28 lower second jaw cylinder, 29a to 29d gripper board, 30a to 30d gripper board shaft, 31A upper transport belt group, 31B lower transport belt group, 32A upper chopper folding apparatus, 32B lower chopper folding apparatus, 33 fan wheel, 34 conveyor, 35a to 35d gripper shaft, 36a to 36d gripper device, 37b, 37d gripper shaft, 38b, 38d gripper, 40A, 40B brush guide device, 41 brush guide, 42 L-bracket, 43 bar, 44a, 44b drive portion, 45a, 45b drive portion body, 46a, 46b bottom plate, 47a, 47b motor, 48a, 48b output shaft, 49a, 49b gear, 50a, 50b top plate, 51a, 51b threaded shaft, 52a, 52b gear, 53a, 53b worm, 54a, 54b worm gear, 55a, 55b rotary encoder, 56a, 56b rotating shaft, 57a, 57b external thread portion, 58a, 58b bracket, 59a, 59b internal thread portion, 60a, 60b pin, 70 frame, 71 stay, 72 guide plate, 80 control device, 81 folding specifications input unit, 82 adjustment input unit.

### BEST MODE FOR CARRYING OUT THE INVENTION

A parallel folding apparatus of a folding machine according to the present invention will now be described in detail by an embodiment with reference to the accompanying drawings.

### Embodiment

FIG. 1 is a schematic side view of a folding machine of a rotary printing press, showing an embodiment of the present invention. FIG. 2 is an enlarged side view of essential parts of the folding machine. FIG. 3 is an enlarged plan view of the essential parts. FIG. 4 is a sectional view taken along line A in FIG. 3. FIG. 5 is a sectional view taken along line B in FIG. 3. FIG. 6 is a sectional view taken along line C in FIG. 3. FIG. 7 is a sectional view taken along line D in FIG. 3. FIG. 8 is a view taken in the direction of an arrow E in FIG. 6. FIG. 9 is a detail view of F in FIG. 3. FIG. 10 is an explanation drawing of the actions of a bar. FIG. 11 is a control block chart.

As shown in FIG. 1, a web W, which has been cooled and dried after printing and then guided to an insert portion of a folding machine, is fed between a pair of nipping rollers 20→a pair of cross perforation cylinders 21→a pair of nipping rollers 22. This web W is then transported to a parallel folding apparatus 23 for cutting the web to predetermined dimensions and folding the cut web. The parallel folding apparatus 23 is equipped with a cut-off cylinder 24, a folding cylinder 25, a first jaw cylinder 26, and upper and lower second jaw cylinders 27, 28, each cylinder rotating in a direction indicated by an arrow in FIG. 1.

The web W fed between the cut-off cylinder 24 and the folding cylinder 25 is cut to predetermined dimensions by a cut-off knife (not shown) of the cut-off cylinder 24, and held by a pin (not shown) of the folding cylinder 25 to be wrapped round the lower circumferential surface of the folding cylinder 25. The cut web (sheet) held by the pin is then gripped by gripper boards 29a to 29d of the first jaw cylinder 26 (the gripper boards 29a to 29d are gripping/holding means provided in large numbers in the axial direction of gripper board shafts 30a to 30d disposed at positions dividing the peripheral surface of the first jaw cylinder 26 into four equal parts) while being half-folded by a knife (not shown) of the folding cylinder 25 acting in cooperation with the gripper boards 29a to 29d. In this manner, a signature is formed and placed in contact with the upper circumferential surface of the first jaw cylinder 26. Knives 64a to 64d (gripping/holding means) are provided in large numbers in the axial direction of knife shafts 65a to 65d disposed at positions dividing the peripheral surface of the first jaw cylinder 26 into four equal parts.

Downstream of the first jaw cylinder 26, the aforementioned upper second jaw cylinder 27 and the aforementioned lower second jaw cylinder 28 are provided in contact with the first jaw cylinder 26. Downstream of the upper second jaw cylinder 27, there are provided an upper transport belt group 31A comprising upper and lower paired transport belts, and an upper chopper folding apparatus 32A located toward a front portion of the upper transport belt group 31A. Downstream of the lower second jaw cylinder 28, there are provided a lower transport belt group 31B comprising upper and lower paired transport belts, and a lower chopper folding apparatus 32B located toward a rear portion of the lower transport belt group 31B. Downstream of the upper transport belt group 31A, there are provided a fan wheel 33 and a conveyor 34 for delivery. The first jaw cylinder 26, the upper second jaw cylinder 27, and the lower second jaw cylinder 28 are connected together by a gear mechanism (not shown) so that they rotate at predetermined rotational speeds.

Many gripper devices (gripping/holding means, herein after referred to as grippers) 36a to 36d are provided in the axial direction of gripper shafts 35a to 35d disposed at positions dividing the peripheral surface of the upper second jaw cylinder 27 into four equal parts. Similarly, many gripper boards (gripping/holding means) 66a to 66d are provided in the axial direction of gripper board shafts 67a to 67d. Moreover, many gripper devices (gripping/holding means, herein after referred to as grippers) 38b, 38d are provided in the axial direction of gripper shafts 37b, 37d disposed at positions dividing the peripheral surface of the lower second jaw cylinder 28 into two equal parts. Similarly, many gripper boards (gripping/holding means) 68b, 68d are provided in the axial direction of gripper board shafts 69b, 69d. The grippers 36a to 36d of the upper second jaw cylinder 27 are sequentially brought into opposed relationship with the gripper boards 29a to 29d of the first jaw cylinder 26, while the grippers 38b, 38d of the lower second jaw cylinder 28 are brought into opposed relationship only with the gripper boards 29b, 29d of the first jaw cylinder 26.

A cam mechanism (not shown; switching means) is provided in the first jaw cylinder 26 to switch the route of transport by performing the following so-called upward merger delivery or so-called up-and-down allocation delivery: The upward merger delivery is a procedure by which the signature transported, one signature at one time, is held by the first jaw cylinder 26 at the position of contact between the folding cylinder 25 and the first jaw cylinder 26 by actuating the gripper boards 29a to 29d at this position, and is then transferred from the gripper boards 29a to 29d of the first jaw cylinder 26 only to the grippers 36a to 36d of the upper second jaw cylinder 27. The up-and-down allocation delivery is a procedure by which the signature transported and held in the above-mentioned manner is transferred alternately from the gripper boards 29a to 29d of the first jaw cylinder 26 to the grippers 36a, 36c of the upper second jaw cylinder 27, and from the gripper boards 29a to 29d of the first jaw cylinder 26 to the grippers 38b, 38d of the lower second jaw cylinder 28.

Furthermore, the rotation phase (position) of gripper opening in the gripper boards 29a to 29d of the first jaw cylinder 26 is switched among three stages by the above cam mechanism, whereby the folding specifications for parallel folding can be changed to single folding, double folding and delta folding. In the folding cylinder 25 as well, the positional relation between the pin and the knife (not shown) can be adjusted by a double cylinder structure according to the above folding specifications. In the upper second jaw cylinder 27 and the lower second jaw cylinder 28 as well, the grippers 36a to 36d and gripper boards 66a to 66d of the upper second jaw cylinder 27, and the grippers 38b, 38d and gripper boards (gripping/holding means) 68b, 68d of the lower second jaw cylinder 28 can be switched by cam mechanisms (not shown) according to the above folding specifications. That is, at the time of double folding and delta folding, gripping change is performed between the knives 64a to 64d of the first jaw cylinder 26 and the gripper boards 66a to 66d of the upper second jaw cylinder 27 and between the knives 64a to 64d of the first jaw cylinder 26 and the gripper boards 68b, 68d of the lower second jaw cylinder 28. At the time of this gripping change, the gripper boards 29a to 29d of the first jaw cylinder 26 make a gripper opening motion.

Along the circumferential surface of the first jaw cylinder 26, brush guide devices 40A, 40B are disposed, respectively, toward the point of contact between the first jaw cylinder 26 (first cylinder) and the upper second jaw cylinder (second cylinder) 27 at a site between the folding cylinder 25 and the upper second jaw cylinder 27, and toward the point of contact between the first jaw cylinder 26 (first cylinder) and the lower second jaw cylinder (second cylinder) 28 at a site between the upper second jaw cylinder 27 and the lower second jaw cylinder 28.

The above-mentioned brush guide device 40A, as shown in FIGS. 2 and 3, comprises a brush guide 41 having many bristles planted into the lower surface of a rectangular arcuate plate elongated in the sheet width direction, and drive portions (drive means) 44a, 44b provided at opposite end portions of a bar 43 which supports the brush guide 41 by a pair of (right and left) L-brackets 42 and extends in the sheet width direction.

The configurations of the drive portions 44a, 44b will be described with reference to FIGS. 4 to 9.

Drive portion bodies 45a, 45b are fixedly provided on a stay 71 extending between frames 70 of the folding machine, and motors 47a, 47b are mounted downwardly on bottom plates 46a, 46b annexed to the drive portion bodies 45a, 45b. Output shafts 48a, 48b of the motors 47a, 47b rotatably pass through the bottom plates 46a, 46b, and gears 49a, 49b are fixedly provided at the front ends of the output shafts 48a, 48b.

Laterally of the drive portion bodies 45a, 45b, threaded shafts 51a, 51b are rotatably passed through and supported by the bottom plates 46a, 46b and top plates 50a, 50b annexed to the drive portion bodies 45a, 45b. Gears 52a, 52b fixedly provided at the lower ends of the threaded shafts 51a, 51b mesh with the aforementioned gears 49a, 49b.

Worms 53a, 53b are fixedly provided at the upper ends of the threaded shafts 51a, 51b, and worm gears 54a, 54b in mesh with the worms 53a, 53b are fixedly provided on rotating shafts 56a, 56b of rotary encoders 55a, 55b supported in a horizontal posture on the aforementioned top plates 50a, 50b.

Internal thread portions 59a, 59b of brackets 58a, 58b of a square cross-section are screwed to external thread portions 57a, 57b formed in intermediate portions of the threaded shafts 51a, 51b. The brackets 58a, 58b are not rotatable because one side surface thereof is in sliding contact with one side surface of the drive portion bodies 45a, 45b.

End portions of the aforementioned bar 43 are joined to one side surface of the brackets 58a, 58b by pins 60a, 60b. Joining portions of the pins 60a, 60b are adapted to permit the inclination, in the sheet width direction, of the bar 43 by, for example, having rubber bushes 61a, 61b (see FIG. 9) interposed into pin holes of the brackets 58a, 58b.

Thus, when the threaded shafts 51a, 51b are rotationally driven by the motors 47a, 47b, the brackets 58a, 58b ascend or descend, whereupon the brush guide 41 is moved toward or away from the circumferential surface of the first jaw cylinder 26 via the guide 43. At this time, the rotary encoders 55a, 55b detect the rotational speed of the threaded shafts 51a, 51b (namely, the ascent or descent amount of the bar 43).

In FIGS. 2 and 3, the numeral 72 denotes a stationary guide plate. The brush guide device 40B has the same configuration as that of the brush guide device 40A. In connection with the brush guide device 40B, therefore, the same members as those in the brush guide device 40A are assigned the same numerals as their numerals, and detailed descriptions will be omitted herein.

The motors 47a, 47b of the brush guide device 40A are driven and controlled, independently of each other, by a control device 80 comprising a microcomputer, etc., as shown in FIG. 11. The same can be said of the motors 47a, 47b of the brush guide device 40B. The control device 80 receives a folding specifications signal from a folding specifications input unit 81 of an operating panel or the like, an adjustment signal from an adjustment input unit 82 of the operating panel, and rotational speed (position) signals from the rotary encoders 55a, 55b. In response to the folding specifications, the control device 80 controls the brush guide 41 so as to be located at a predetermined adjustment position, and exercises feedback control of the adjustment position.

Because of the above-described features, at the time of double folding (or delta folding) and up-and-down allocation delivery, the brush guide 41 in the brush guide device 40A and the brush guide device 40B is controlled so as to come to a predetermined adjustment position which is closer to the circumferential surface of the first jaw cylinder 26 than during single folding. That is, the contact pressure on the signature is increased as compared with single folding.

Thus, when the signature after single folding between the folding cylinder 25 and the first jaw cylinder 26 is parallel-folded between the double folding knives (not shown) of the first jaw cylinder 26 and the grippers 36a, 36c of the upper second jaw cylinder 27 and between these knives and the grippers 38b, 38d of the lower second jaw cylinder 28 for double folding (or delta folding) an appropriate contact pressure by the brush guide 41 is applied to the signature, whereby the signature is transported in a stable state. Hence, the drawback that the rear end of the signature is bent does not occur.

If the operator visually detects a bend of the signature in the delivery unit of the printing press, the operator enters an adjustment value corresponding to the bend at the adjustment input unit 82 of the operating panel present in the delivery unit to control one of (or both of) the right and left motors 47a, 47b in one of (or both of) the brush guide devices 40A, 40B. By so doing, the bend can be corrected easily.

At the time of single folding and up-and-down allocation delivery or upward merger delivery, on the other hand, it is advisable to render the brush guide 41 in the brush guide devices 40A, 40B more remote from the circumferential surface of the first jaw cylinder 26 than during the above-mentioned double folding, or to release the brush guide 41 completely from the circumferential surface of the first jaw cylinder 26. In case of double folding (or delta folding) and upward merger delivery, it is advisable to separate the brush guide 41 in the brush guide device 40B from the circumferential surface of the first jaw cylinder 26, or to release the brush guide 41 completely from the circumferential surface of the first jaw cylinder 26.

By so doing, the unnecessary contact of the brush guide 41 with the signature can be avoided, so that the wear of the brush guide 41 can be prevented to prolong its life.

According to the present invention, as described above, the motors 47a, 47b in the brush guide devices 40A, 40B are controlled, whereby the position control of the brush guide 41 can be exercised automatically according to the folding specifications while the machine is in operation to adjust the contact pressure, etc. Thus, productivity and folding accuracy can be improved.

Moreover, the motors 47a, 47b are provided at opposite end portions of the bar 43 which extends in the sheet width direction while supporting the brush guide 41. These motors 47a, 47b are driven and controlled, independently of each other, by the control device 80. This produces the advantage that meticulous control can be performed in the width direction of the signature. For example, as shown in FIGS. 9 and 10, the joining portions of the pins 60a, 60b are adapted to allow the inclination of the bar 43 in the sheet width direction by, for example, having the rubber bushes 61a, 61b interposed into the pin holes of the brackets 58a, 58b. Thus, it is possible to make fine adjustment of the contact pressure, etc. of the brush guide 41, with only one end of the bar 43 being raised or lowered. Furthermore, the bar 43, namely, the brush guide 41, is moved via the threaded shafts 51a, 51b and brackets 58a, 58b by the motors 47a, 47b furnished with the rotary encoders 55a, 55b. Thus, the advantage is obtained that high accuracy control is possible.

The present invention is not limited to the above embodiment, but various changes and modifications, such as change of the drive means, may be made without departing from the gist of the present invention. Moreover, the transfer of the signature from the gripper boards to the grippers may be changed to the transfer of the signature from the grippers to the grippers. In addition, the first jaw cylinder is disclosed as an example of the first cylinder, and the upper second jaw cylinder or the lower second jaw cylinder is disclosed as an example of the second cylinder. However, the folding cylinder may be the first cylinder, and the first jaw cylinder may be the second cylinder. In this case, the cut web is guided by the brush guide so that it is not bent during single parallel folding and, for sheet passage (when the sheet is not folded), the brush guide is rendered more separate from the circumferential surface of the first cylinder than during single parallel folding.

### INDUSTRIAL APPLICABILITY

The parallel folding apparatus of the folding machine according to the present invention can be applied to a sheet-fed printing press as well as to a web rotary press, and can also be applied to a coating machine as well as to a printing press.

1. A parallel folding apparatus of a folding machine, comprising:
a first cylinder and a second cylinder arranged, with circumferential surfaces of said first cylinder and said second cylinder being in contact with each other, gripping/holding means of said second cylinder being arranged to parallel-fold a sheet in cooperation with knives of said first cylinder; and
a brush guide disposed along the circumferential surface of said first cylinder located upstream, in a rotating direction, of a point of contact between said first cylinder and said second cylinder,
and wherein said brush guide is provided so as to be movable toward and away from the circumferential surface of said first cylinder by drive means.

2. The parallel folding apparatus of a folding machine according to claim 1, characterized in that
said brush guide is located at an operating position close to the circumferential surface of said first cylinder when the sheet is folded between said first cylinder and said second cylinder, and
said brush guide is separated from said operating position when the sheet is not folded between said first cylinder and said second cylinder.

3. The parallel folding apparatus of a folding machine according to claim 1, characterized in that
said first cylinder is a first jaw cylinder for forming a signature in cooperation with a folding cylinder, and
said second cylinder is a second jaw cylinder for folding said signature in cooperation with said first jaw cylinder, or for receiving said signature from said first jaw cylinder without folding said signature.

4. The parallel folding apparatus of a folding machine according to claim 3, further comprising a plurality of said second jaw cylinders and a plurality of said brush guides.

5. The parallel folding apparatus of a folding machine according to claim 1, characterized in that
said drive means are provided at opposite end portions of a bar, which extends in an axial direction while supporting said brush guide, and are driven and controlled independently of each other.

6. The parallel folding apparatus of a folding machine according to claim 1, characterized in that
said drive means comprises a motor, a threaded shaft driven by said motor, and a bracket screwed to said threaded shaft, and
aid bar is supported pivotably about said bracket.

7. The parallel folding apparatus of a folding machine according to claim 1, characterized in that
said drive means is provided at a bar supporting said brush guide, and is driven and controlled according to folding specifications by control means.

8. The parallel folding apparatus of a folding machine according to claim 1, further comprising
a folding specifications input unit for inputting folding specifications, and
control means for controlling said drive means according to the folding specifications inputted into said folding specifications input unit.

9. The parallel folding apparatus of a folding machine according to claim 8, further comprising
an adjustment input unit for actuating said drive means to adjust a contact pressure of said brush guide on said sheet being parallel-folded.

10. The parallel folding apparatus of a folding machine according to claim 9, characterized in that
said drive means is a pair of motors provided at opposite end portions of said brush guide, and
said control device controls at least one of said pair of motors based on an input into said adjustment input unit.

11. The parallel folding apparatus of a folding machine according to claim 4, characterized in that
said second jaw cylinder comprises an upper second jaw cylinder and a lower second jaw cylinder paired with said brush guides,
and characterized by being capable of performing upward merger delivery for transferring the sheet from said first jaw cylinder only to said upper second jaw cylinder, and up-and-down allocation delivery for transferring the sheet alternately from the first jaw cylinder to the upper second jaw cylinder, and from the first jaw cylinder to the lower second jaw cylinder,
and further comprising control means for controlling said drive means so as to separate said brush guide located beside said lower second jaw cylinder from an operating position during said upward merger delivery.
